(19) United States
(12) Patent Application Publication
(10) Pub. No.: US 2015/0233960 A1
(43) Pub. Date: Aug. 20, 2015

(54) MONITORING DEVICE AND MONITORING METHOD

(71) Applicant: FUJITSU LIMITED, Kawasaki-shi (JP)

(72) Inventor: AKIHIRO KAWAZU, NUMAZU (JP)

(21) Appl. No.: 14/594,204

(22) Filed: Jan. 12, 2015

(30) Foreign Application Priority Data
Feb. 18, 2014 (JP) 2014-028471

(51) Int. Cl. G01P 5/10

(52) U.S. Cl. CPC G01P 5/10

(57) ABSTRACT

A disclosed monitoring device includes: a wind speed acquiring unit configured to acquire the wind speed of cooing wind at each of a plurality of wind speed measuring points set in an opening portion of a floor of a datacenter, the cooling wind being supplied through the opening portion into an electronic apparatus; a state pattern specifying unit configured to specify which one of a plurality of pre-categorized state patterns the state of the cooling wind matches, based on the wind speed at each of the wind speed measuring points; and an abnormality specifying unit configured to specify the type of abnormality in the datacenter based on the specified state pattern.

### CROSS-REFERENCE TO RELATED APPLICATION(s)

This application is based upon and claims the benefit of priority of the prior Japanese Patent Application No. 2014-28471, filed on Feb. 18, 2014, the entire contents of which are incorporated herein by reference.

### FIELD

The embodiment discussed herein is related to a monitoring device and a monitoring method.

### BACKGROUND

In datacenters, jobs are distributed to a plurality of electronic apparatuses such as servers, and each electronic apparatus executes its jobs. Each electronic apparatus is provided with an electronic component such as a central processing unit (CPU). When processing a large amount of jobs, the temperature of the electronic component rises, which may result in failure of the electronic apparatus or deterioration in the performance thereof.

To deal with this problem, in datacenters, cooling air generated by air conditioners is supplied to electronic apparatuses, and the electronic components are cooled with the cooling air.

According to this, failure of the electronic apparatuses can be expected to be prevented. However, depending on the environment in which the electronic apparatuses are installed, the electronic components may not be cooled appropriately, and the life of the electronic components may be shortened.

A method is proposed to deal with this problem. In this method, the life of an electronic component is estimated by monitoring the temperature of the environment in which the electronic component is placed. Then, when it is determined that the end of life is reached, user is prompted to replace the electronic component.

Note that technologies related to this application are disclosed in Japanese Laid-open Patent Publication Nos. 2009-104322, 2001-60785, and 07-333015.

### SUMMARY

According to one aspect discussed herein, there is provided a monitoring device including a wind speed acquiring unit that acquires a wind speed of a cooing wind at each of a plurality of wind speed measuring points set in an opening portion of a floor of a datacenter, the cooling wind being supplied through the opening portion into an electronic apparatus, a state pattern specifying unit that specifies which one of a plurality of preliminarily categorized state patterns is matched with a state of the cooling wind, based on the wind speed at each of the wind speed measuring points, and an abnormality specifying unit that specifies a type of abnormality in the datacenter based on the specified state pattern.

Also, according to another aspect discussed herein, there is provided a monitoring method including acquiring, by a wind speed acquiring unit, a wind speed of a cooing wind at each of a plurality of wind speed measuring points set in an opening portion of a floor of a datacenter, the cooling wind being supplied through the opening portion into an electronic apparatus, specifying, by a state pattern specifying unit, which one of a plurality of preliminarily categorized state patterns is matched with a state of the cooling wind, based on the wind speed at each of the wind speed measuring points, and specifying, by an abnormality specifying unit, a type of abnormality in the datacenter based on the specified state pattern.

Moreover, according to other aspect discussed herein, there is provided a monitoring device including a memory configured to store a program, and a processor, in accordance with the program, configured to execute acquiring a wind speed of a cooing wind at each of a plurality of wind speed measuring points set in an opening portion of a floor of a datacenter, the cooling wind being supplied through the opening portion into an electronic apparatus that is in the data center, specifying which one of a plurality of preliminarily categorized state patterns is matched with a state of the cooling wind, in accordance with the wind speed at each of the wind speed measuring points, and specifying a type of abnormality in the datacenter in accordance with the specified state pattern.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a schematic cross-sectional view of a datacenter 1 to be monitored in an embodiment;

FIG. 2 is a top view of one of opening portions provided in the floor of a datacenter;

FIG. 3 is a schematic view of a measurement jig used in the present embodiment;

FIG. 4A is a schematic perspective view illustrating an example of wind speed sensors used in the present embodiment;

FIG. 4B is a schematic perspective view illustrating an example of wind direction sensors used in the present embodiment;

FIG. 5 is a hardware configuration diagram of a monitoring device according to the present embodiment;

FIG. 6 is a functional block diagram of the monitoring device according to the present embodiment;

FIG. 7 is a schematic diagram for describing cooling wind in a pattern A;

FIG. 8 is a schematic diagram for describing cooling wind in a pattern B;

FIG. 9 is a schematic diagram for describing cooling wind in a pattern C;

FIG. 10 is a schematic diagram for describing cooling wind in a pattern D;

FIG. 11 is a schematic diagram for describing cooling wind in a pattern E;

FIG. 12 is a diagram schematically illustrating a state pattern database;

FIG. 13 is a diagram schematically illustrating a temperature database;

FIG. 14 is a diagram schematically illustrating an error database;

FIG. 15 is a diagram schematically illustrating a comprehensive judgment database;

FIG. 16 is a flowchart illustrating the whole procedure of a monitoring method according to the present embodiment;

FIG. 17A is a flow chart illustrating the procedure of a monitoring process according to the present embodiment (part 1);

FIG. 17B is a flow chart illustrating the procedure of the monitoring process according to the present embodiment (part 2);

FIG. 18 is a table schematically illustrating wind speeds and wind directions acquired in a first examination;

FIG. 19 is a table schematically illustrating the temperatures inside racks acquired in the first examination;

FIG. 20 is a table schematically illustrating error information acquired in the first examination;

FIG. 21 is a table gathering the results of the first examination;

FIG. 22 is a side view schematically illustrating racks used in a second examination and their periphery;

FIG. 23 is a plan view schematically illustrating the opening portions immediately below the racks in FIG. 22;

FIG. 24 is a table illustrating the results of measurement of the wind speed and wind direction of cooling wind at measuring points 13 to 18 in the left rack in FIG. 22;

FIG. 25 is a table illustrating the results of measurement of the wind speed and wind direction of the cooling wind at the measuring points 13 to 18 in the right rack in FIG. 22;

FIG. 26 is a table illustrating the results of measurement of the wind speed and wind direction of the cooling wind at measuring points 10 to 12 in each of the left and right racks in FIG. 22; and

FIG. 27 is a table illustrating the results of measurement of the wind speed and wind direction of the cooling wind at measuring points 19 to 21 in each of the left and right racks in FIG. 22.

### DESCRIPTION OF EMBODIMENT

In the following, an embodiment will be described with reference to the accompanying drawings.

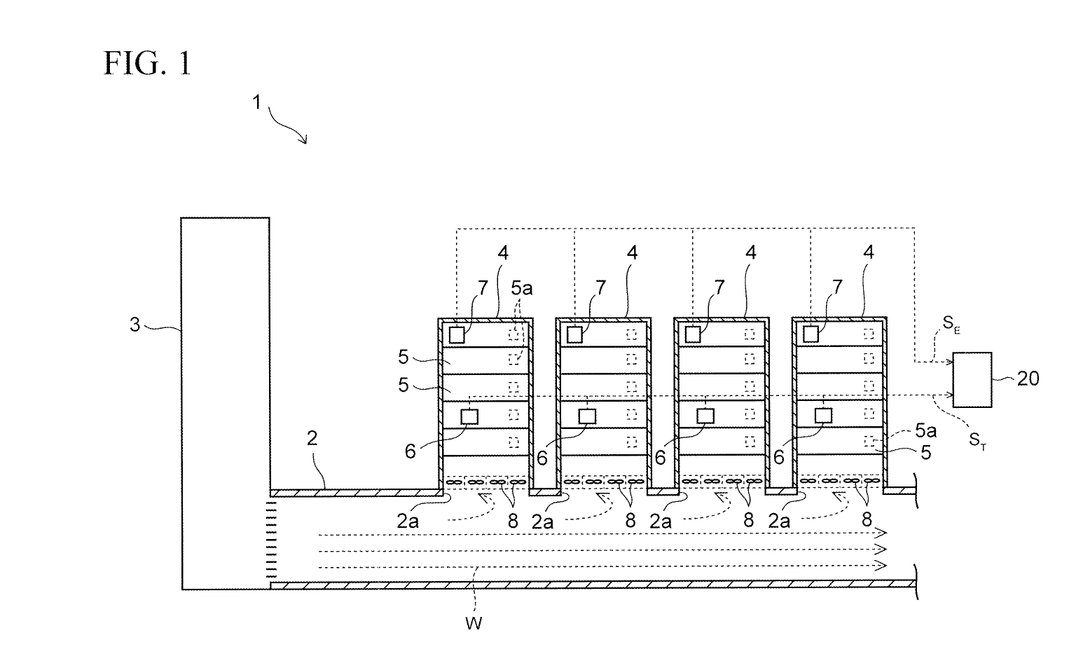

FIG. 1 is a schematic cross-sectional view of a datacenter 1 to be monitored in the present embodiment.

The datacenter 1 includes a floor 2 and an air conditioner 3. The air conditioner 3 is configured to generate cooling wind W cooled to a predetermined temperature and supply the cooling wind W to a space underneath the floor 2.

The floor 2 is provided with a plurality of opening portions 2a, and the cooling wind W flows upward from the floor through the opening portions 2a.

A rack 4 is installed immediately above each opening portion 2a. Each rack 4 is, for example, a server rack. Rack 4 is configured to house a plurality of electronic apparatuses 5. Electronic apparatus 5 is not limited to a particular apparatus. In this example, a server including an electronic component 5a such as a CPU is used as the electronic apparatus 5.

Moreover, fans 8 are provided to each rack 4 at a portion where the opening portion 2a faces. The fans 8 function to take the cooling wind W flowing upward through the opening portion 2a into the rack 4 and cool the electronic apparatuses 5 with the cooling wind W.

Further, a temperature measuring unit 6 and an error detecting unit 7 are provided in each rack 4.

The temperature measuring unit 6 is a temperature sensor configured to measure temperature T around the electronic apparatuses 5 and output temperature information S_{T} containing the temperature T.

On the other hand, the error detecting unit 7 is configured to gather error information S_{E} sent from the electronic components 5a housed in the single rack 4 and output the error information S_{E}. The error information S_{E} is information on the presence of the failure in the electronic component 5a. For example, the error information S_{E} is an interface (I/F) error outputted from the CPU.

The temperature information S_{T} and the error information S_{E} are sent to a monitoring device 20 to be described later.

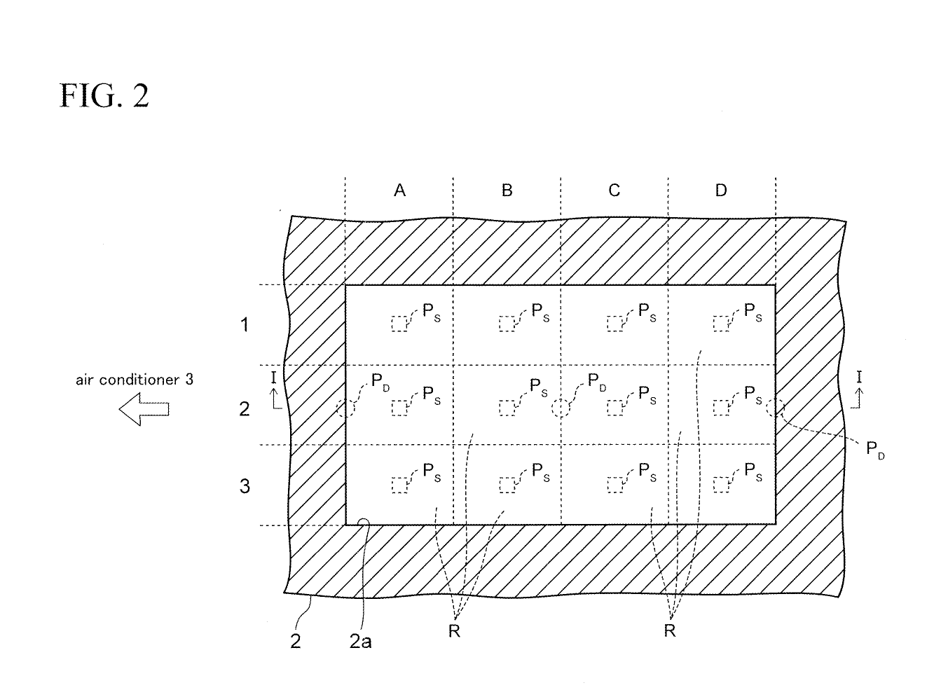

FIG. 2 is a top view of an opening portion 2a. Note that the cross-section of each opening portion 2a in FIG. 1 corresponds to a cross section taken along line I-I in FIG. 2.

As illustrated in FIG. 2, the opening portion 2a has a rectangular shape in a plan view.

In this example, the opening portion 2a is divided into a plurality of virtual regions R to form matrix-like shape. Here, the columns are denoted by reference signs A, B, C, and D in this order from the air conditioner 3 (see FIG. 1) side. Moreover, the rows are denoted by reference signs 1, 2, and 3, and each virtual region R is specified by a combination of the reference signs A, B, C, D, 1, 2, and 3.

Provided in the opening 2a are a plurality of wind speed measuring points P_{S} for measuring the wind speed of the cooling wind W, and plurality of wind direction measuring points P_{D} for measuring the wind direction of the cooling wind W.

Among these points, the single wind speed measuring points P_{S} is provided in the single virtual regions R. On the other hand, the wind direction measuring points P_{D} overlaps with the adjacent virtual regions R. In this example, the wind direction in the virtual region R at the column A is measured at the left wind direction measuring point P_{D}, and the wind direction in the virtual regions R at the columns B and C is measured at the center wind direction measuring point P_{D}. Moreover, the wind direction in the virtual region R at the column D is measured at the right wind direction measuring point P_{D}.

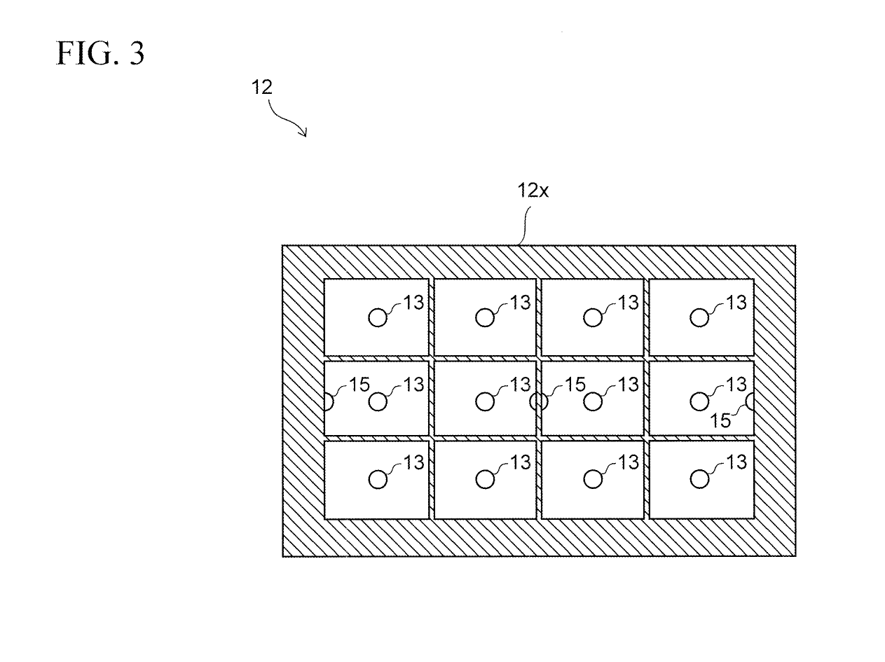

FIG. 3 is a schematic view of a measurement jig configured to be fitted to the opening portion 2a.

This measurement jig 12 is used for measuring the wind speed and wind directions of the cooling wind W passing through the opening portion 2a, and includes a frame 12x of a rectangular shape corresponding to the rectangular shape of the opening portion 2a.

Moreover, in the frame 12x, a wind speed sensor 13 is provided at the position that corresponds to the wind speed measuring points P_{S}, and a wind direction sensor 15 is provided at the position that corresponds to the wind direction measuring points P_{D}.

Note that the wind speed sensors 13 and the wind direction sensors 15 are fixed to the frame 12x with metal wires.

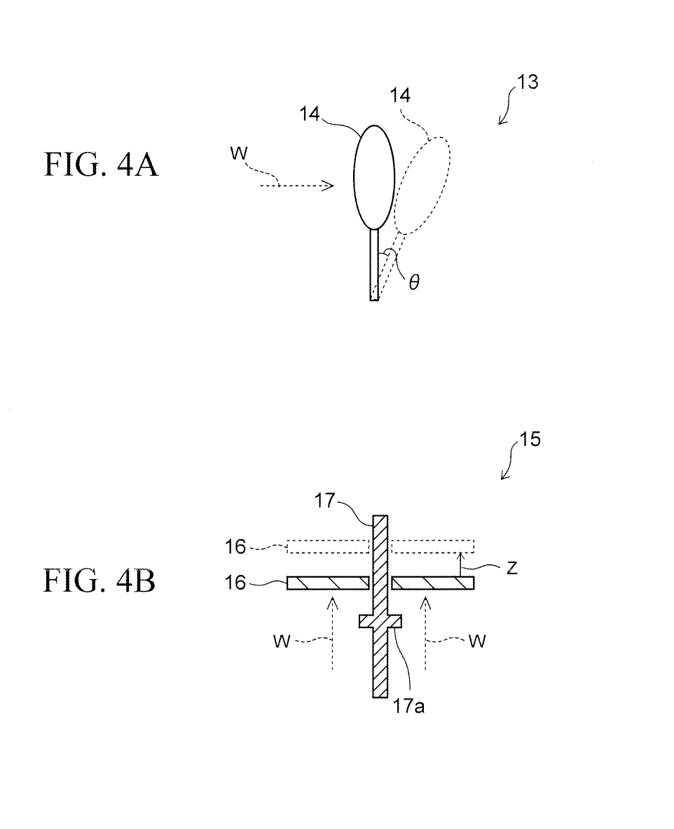

FIG. 4A is a schematic perspective view illustrating an example of the wind speed sensors 13, and

FIG. 4B is a schematic perspective view illustrating an example of the wind direction sensors 15.

As illustrated in FIG. 4A, each wind speed sensor includes a wind receiving plate 14 configured to tilt when receiving the cooling wind W, and is configured to convert an angle e of the tilt into the wind speed of the cooling wind W and output wind speed information S_{S} containing this wind speed.

On the other hand, as illustrated in FIG. 4B, each wind direction sensor 15 includes a wind receiving plate 16 configured to move up and down along a shaft 17 when receiving the cooling wind W. The shaft 17 extends vertically and includes a stopper 17a configured to limit downward displacement of the wind receiving plate 16.

The wind direction sensor 15 is configured to output a displacement amount z of the wind receiving plate 16 along the shaft 17 as wind direction information S_{D}. When the displacement amount z of displacement is a positive value, the wind direction of the cooling wind W is vertically upward. When the displace amount z of displacement is 0, the wind direction of the cooling wind W is vertically downward, or there is no wind.

Next, the monitoring device 20 will be described.

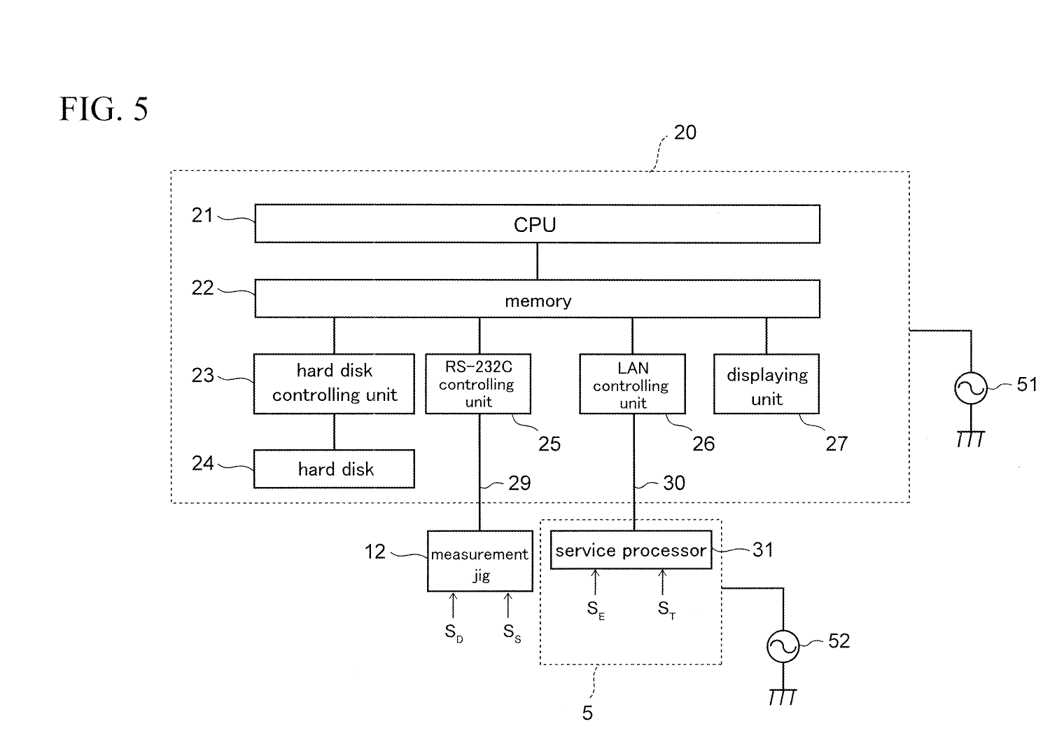

FIG. 5 is a hardware configuration diagram of the monitoring device 20.

In the present embodiment, a mobile device such as a laptop computer is used as the monitoring device 20, and the abnormality in the datacenter 1 is monitored with the monitoring device 20.

The monitoring device 20 includes a CPU 21, a memory 22, a hard disk controlling unit 23, a hard disk 24, an RS-232C controlling unit 25, a local area network (LAN) controlling unit 26, and a displaying unit 27.

Among them, the hard disk controlling unit 23 is configured to control input and output of data between the hard disk 24 and the memory 22. Moreover, the RS-232C controlling unit 25 is connected to each measurement jig 12 by an RS-232C cable 29 and configured to control communication with the wind speed sensors 13 (see FIG. 3) and the wind direction sensors 15 based on the RS-232C standard.

Moreover, the LAN controlling unit 26 is connected to each electronic apparatus 5 mentioned above through a LAN cable 30 and is configured to control communication with the electronic apparatus 5 based on the Ethernet standard.

Note that a service processor 31 is provided to the electronic apparatus 5, and the temperature information S_{T} and the error information S_{E} are sent to the monitoring device 20 through the service processor 31 and the LAN cable 30.

The RS-232C cable 29 and the LAN cable 30 are detachable to the monitoring device 20. Thus, these cables 29 and 30 may be attached to the monitoring device 20 only when the monitoring device 20 is used.

Moreover, the displaying unit 27 is a liquid crystal display for example, and used to display the type of abnormality in the datacenter 1.

The monitoring device 20 is driven by a power source 51 of AC 100 V, and each electronic apparatus 5 is driven by a power source 52 of AC 100 V or AC 200 V.

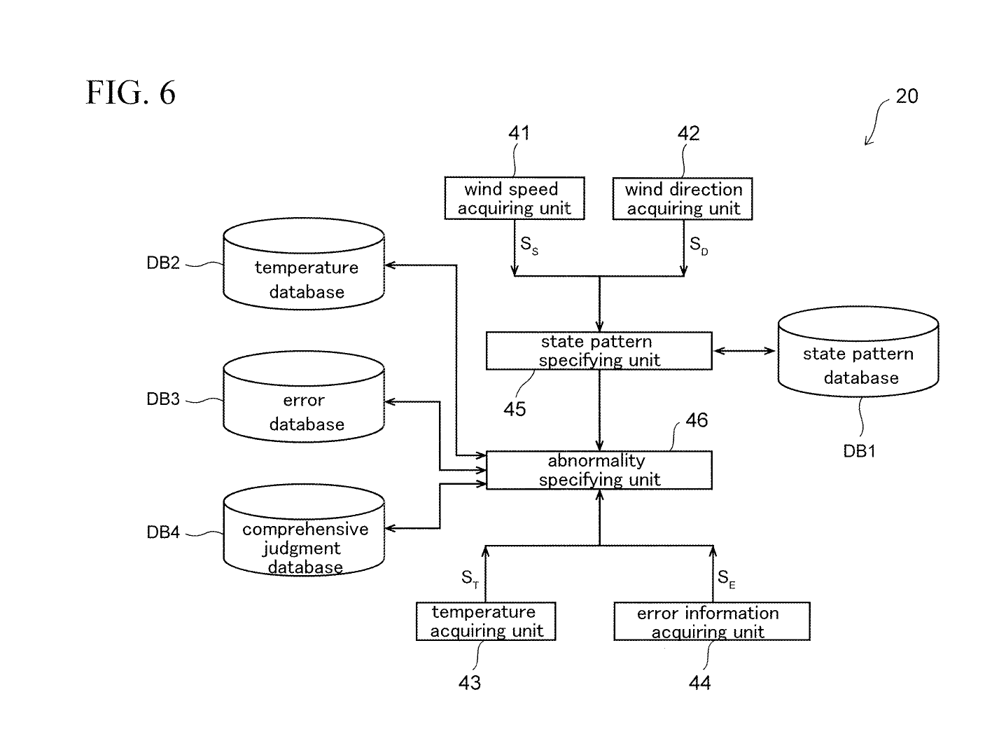

FIG. 6 is a functional block diagram of the monitoring device 20.

The monitoring device 20 includes a wind speed acquiring unit 41, a wind direction acquiring unit 42, a temperature acquiring unit 43, an error information acquiring unit 44, a state pattern specifying unit 45, and an abnormality specifying unit 46.

Each of these units can be implemented by installing a specialized program onto the hard disk 24 (see FIG. 5) and executing the program with a combination of the CPU 21 and the memory 22.

The wind speed acquiring unit 41 has a function of acquiring the wind speed information S_{S} from the wind speed sensors 13. The wind direction acquiring unit 42 has a function of acquiring the wind direction information S_{D} from the wind direction sensors 15.

Moreover, the temperature acquiring unit 43 has a function of acquiring the temperature information S_{T} from each temperature measuring unit 6. The error information acquiring unit 44 has a function of acquiring the error information S_{E} from each error detecting unit 7.

The state pattern specifying unit 45 is configured to receive the wind speed information S_{S} and the wind direction information S_{E} from the wind speed acquiring unit 41 and the wind direction acquiring unit 42 respectively. Based on these information S_{S} and S_{E}, the state pattern specifying unit 45 specifies the state of the cooling wind W flowing upward through the opening portion 2a. A state pattern database DB1 is used for this specification.

The abnormality specifying unit 46 is configured to specify the type of abnormality in the datacenter in a manner described later, based on the state pattern specified by the state pattern specifying unit 45. Note that the abnormality specifying unit 46 refers to a temperature database DB2, an error database DB3, and a comprehensive judgment database DB4 to specify the type of abnormality.

Next, the state pattern of the cooling wind W to be specified by the state pattern specifying unit 45 will be described.

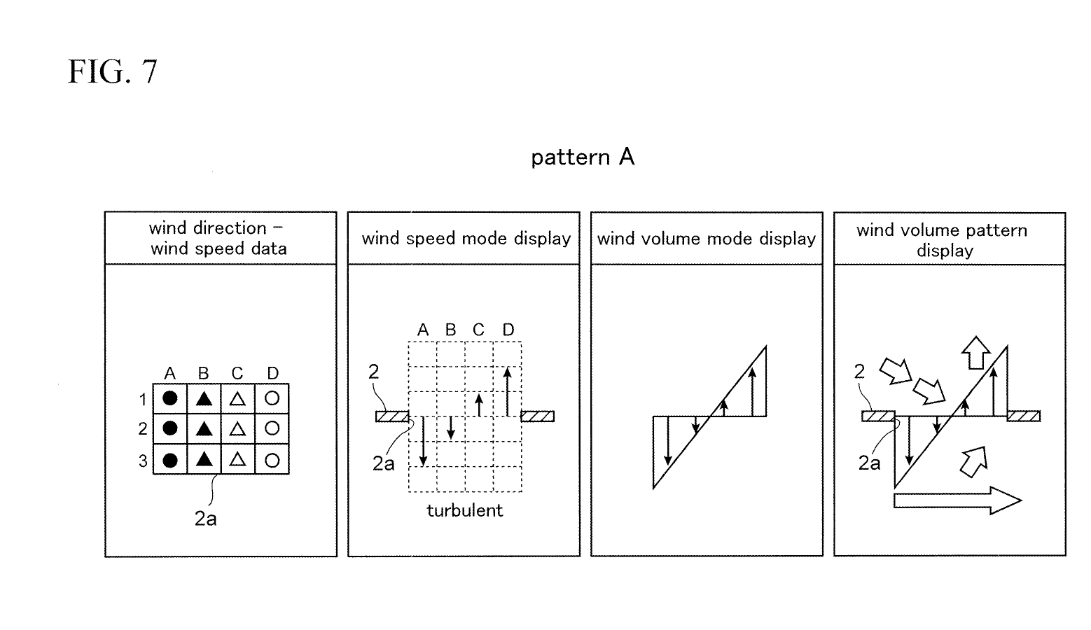

FIGS. 7 to 11 are schematic diagrams for describing state patterns of the cooling wind W.

In FIGS. 7 to 11, symbols ⊚, ∘, Δ, x, ▴, and are employed in order to simultaneously indicate the wind direction and wind speed of the cooling wind W. The definitions of the symbols are as follows.

⊚: forward wind at a wind speed two or more times higher than a reference wind speed.

∘: forward wind at a wind speed equal to or higher than the reference wind speed.

Δ: forward wind at a wind speed lower than the reference wind speed.

x: no wind.

▴: backward wind at a wind speed lower than the reference wind speed.

: backward wind at a wind speed equal to or higher than the reference wind speed.

Here, the reference wind speed is a wind volume with which to determine the strength of the cooling wind W flowing through the opening portion 2a, and is defined in this example as (reference wind volume)/(area of opening portion 2a). In this definition, the reference wind volume is set by the user in advance.

Further, FIGS. 7 to 11 illustrate “wind direction-wind speed data,” “wind speed mode display”, “wind volume mode display”, and “wind volume pattern display”.

Among them, “wind direction-wind speed data” is a schematic plan view which indicates the wind speeds and wind directions of the cooling wind W flowing through the opening portion 2a, and uses the reference signs A, B, C, D, 1, 2, and 3 in FIG. 2 to indicate the virtual regions R of the opening portion 2a.

Moreover, “wind speed mode display” is a schematic cross-sectional view which displays the wind speeds of the cooling wind W. The directions of arrows indicate the wind directions, and the lengths of the arrows indicate the wind speeds.

Further, “wind volume mode display” is a schematic cross-sectional view which displays the wind volumes of the cooling wind W. Polygon, which encircles arrows indicating the wind speeds and wind directions, schematically indicates the wind volumes.

Moreover, “wind volume pattern display” is the drawing in which the above-described “wind volume mode display” is provided with outlined arrows that indicates airflows around the opening portion 2a.

FIG. 7 illustrates a pattern A.

The pattern A is a state pattern in which the cooling wind W is backward wind in regions of the opening portion 2a closer to the air conditioner 3.

“Wind speed mode display” for the pattern A is “turbulent”.

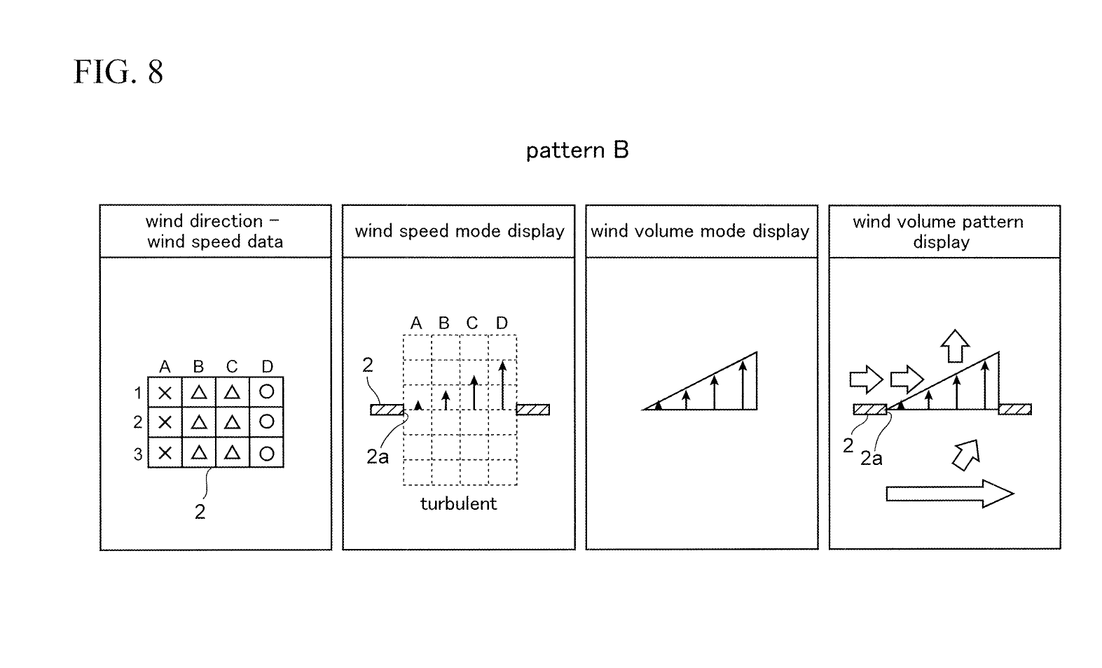

FIG. 8 illustrates a pattern B.

The pattern B is a state pattern in which there is no backward wind but the wind speed of the cooling wind W is low in regions of the opening portion 2a closer to the air conditioner 3 and becomes higher in a direction away from the air conditioner 3.

For the pattern B too, “wind speed mode display” is “turbulent”.

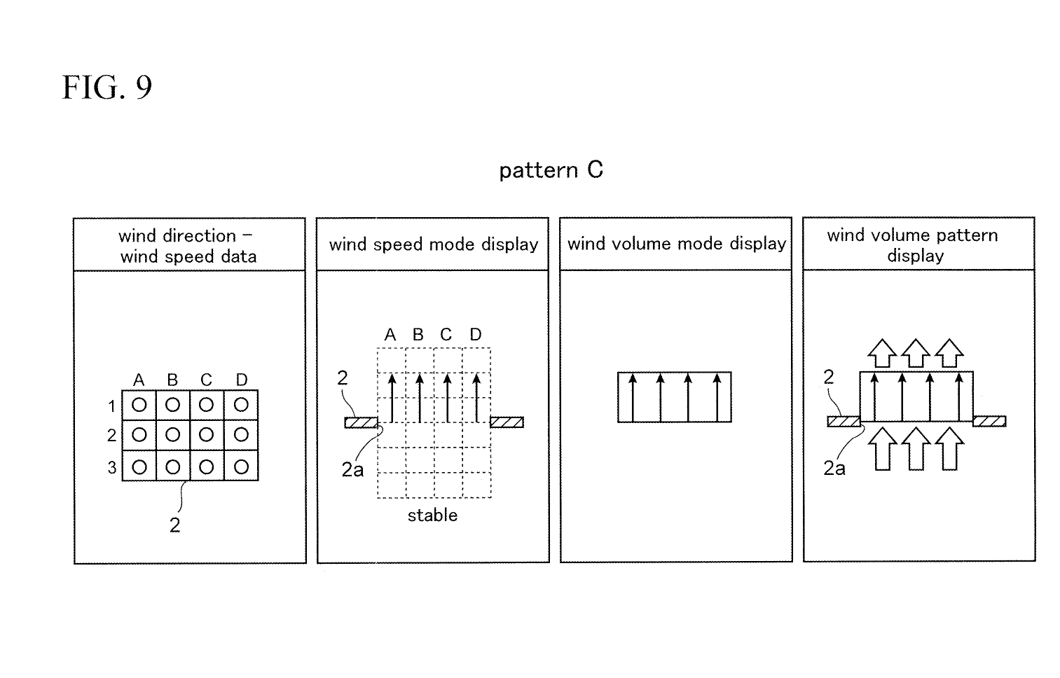

FIG. 9 illustrates a pattern C.

The pattern C is a state pattern in which the cooling wind W is forward wind and the wind volume of the cooling wind W is equal to or higher than the reference wind speed in all the regions of the opening portion 2a.

“Wind speed mode display” for the pattern C is “stable.”

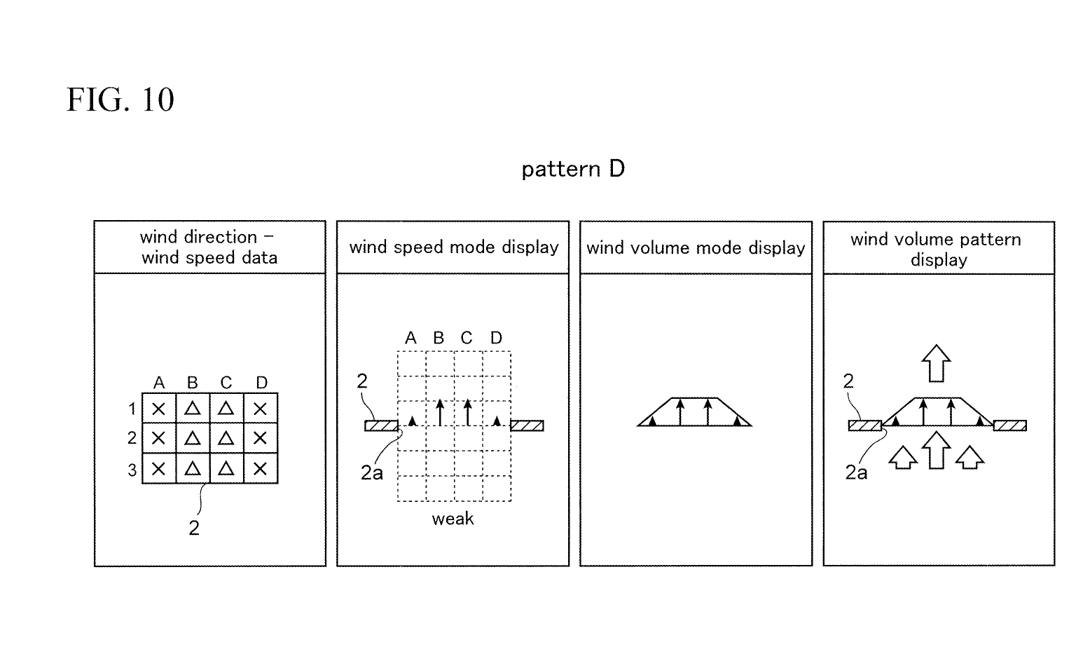

FIG. 10 illustrates a pattern D.

The pattern D is a state pattern in which the wind volume is low at edges of the opening portions 2a, and “wind speed mode display” is “weak.”

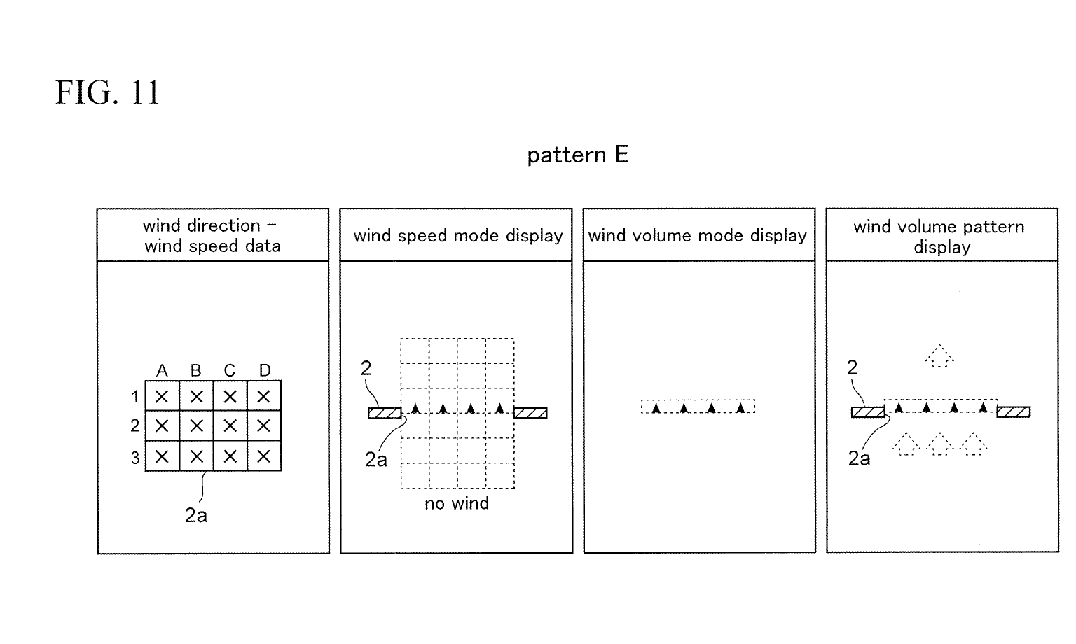

FIG. 11 illustrates a pattern E.

The pattern E is a state pattern in which there is no wind in all the regions of the opening portion 2a, and “wind speed mode display” is “no wind.”

In the examples of FIGS. 7 to 11, both the wind speed and wind direction of the cooling wind W are used to categorize state patterns of the cooling wind W into the pattern A to the pattern E. Note, however, that only the wind speed may be used to categorize state patterns of the cooling wind W.

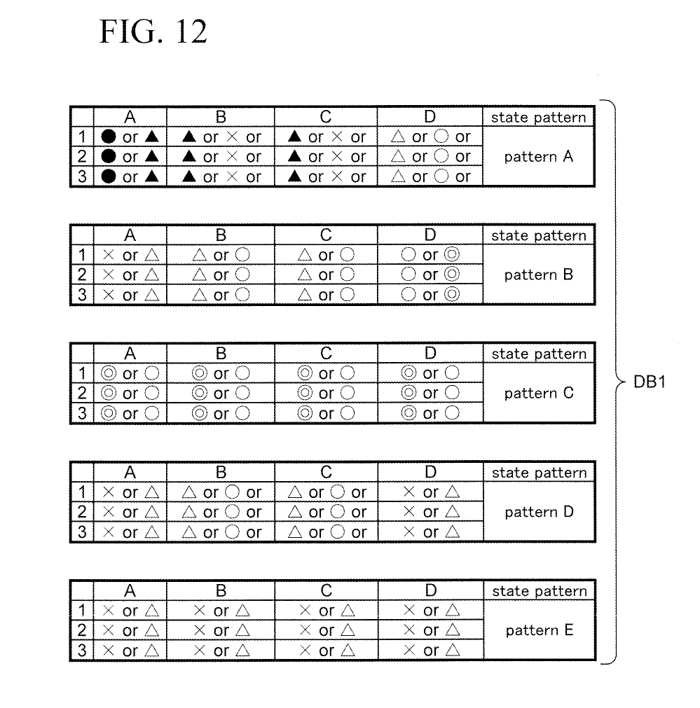

FIG. 12 is a diagram schematically illustrating the state pattern database DB1 mentioned above.

As illustrated in FIG. 12, the state pattern database DB1 has, as attributes, the reference signs A, B, C, D, 1, 2, and 3 for specifying each virtual region R, and “state pattern.” Moreover, as the attribute values of the reference signs A, B, C, D, 1, 2, and 3, any of the symbols ⊚, ∘, Δ, x, ▴, and is stored. Furthermore, as the attribute value of “state pattern,” any of the patterns A to E described with reference to FIGS. 7 to 11 is stored.

When a query specifying wind speeds and wind directions as attribute values for the reference signs A, B, C, D, 1, 2, and 3 is made into the state pattern database DB1, the state pattern database DB1 returns the attribute value of “state pattern” corresponding to these attribute values.

Note that, in the case of using only wind speeds to categorize state patterns in FIGS. 7 to 11, only a wind speed may be stored as the attribute value of each of the reference signs A, B, C, D, 1, 2, and 3 in the state pattern database DB1.

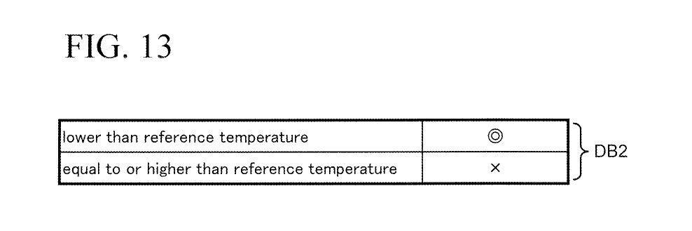

FIG. 13 is a diagram schematically illustrating the temperature database DB2 mentioned above.

As illustrated in FIG. 13, the temperature database DB2 has two attributes of “lower than reference temperature” and “equal to or higher than reference temperature”, in which symbols “⊚” and “x” are stored as attribute values, respectively.

Note that the reference temperature is the upper limit temperature in the range of temperatures within which the operation of the electronic apparatuses 5 is guaranteed, and is set by the user in advance.

The temperature database DB2 is referred to by the abnormality specifying unit 46 as mentioned above. The temperature database DB2 returns “⊚” to the abnormality specifying unit 46 when the temperature T contained in the temperature information S_{T} is lower than the reference temperature, and returns “x” to the abnormality specifying unit 46 when the temperature T is equal to or higher than the reference temperature.

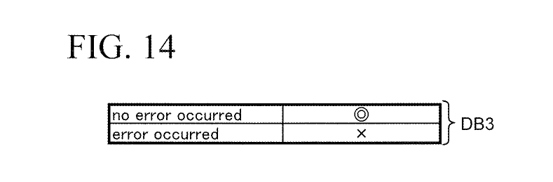

FIG. 14 is a diagram schematically illustrating the error database DB3 mentioned above.

As illustrated in FIG. 14, the error database DB3 has two attributes of “no error occurred” and “error occurred”, in which symbols “⊚” and “x” are stored as attribute values, respectively.

The error database DB3 is referred to by the abnormality specifying unit 46 as mentioned above. The error database DB3 returns “x” to the abnormality specifying unit 46 when failure is found in any one of the plurality of electronic components 5a in one rack 4 based on the error information S_{E}. On the other hand, the error database DB3 returns “⊚” to the abnormality specifying unit 46 when no failure is found in any one of the electronic components 5a in one rack 4 based on the error information S_{E}.

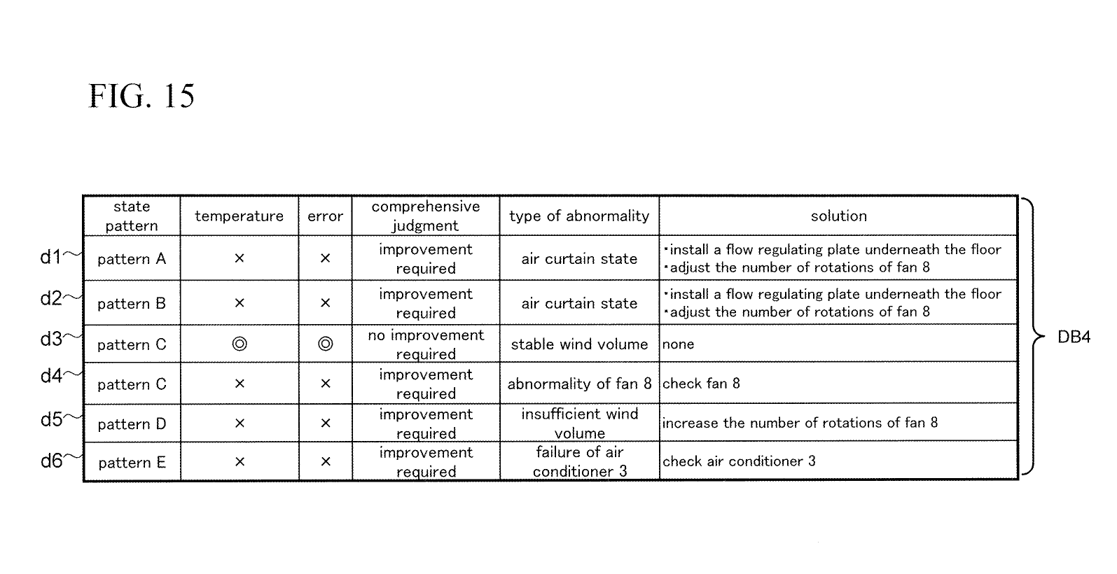

FIG. 15 is a diagram schematically illustrating the comprehensive judgment database DB4.

The comprehensive judgment database DB4 is a database in which the types of abnormality in the datacenter 1 are associated with “state pattern” mentioned above, and has attributes of “state pattern”, “temperature”, “error”, “comprehensive judgment”, “type of abnormality”, and “solution”.

Among these attributes, “state pattern” is the same as the attribute “state pattern” in the state pattern database DB1 (see FIG. 12).

Moreover, in the attribute “temperature”, the attribute values of “⊚” and “x” in the temperature database DB2 (see FIG. 13) are stored.

In the attribute “error”, the attribute values of “⊚” and “x” in the error database DB3 (see FIG. 14) are stored.

The attribute “comprehensive judgment” is an attribute, which stores the result of determination of whether or not it is necessary to improve the environment in the datacenter 1.

Further, the attribute “type of abnormality” is an attribute which stores possible types of abnormality in the datacenter 1.

Lastly, the attribute “solution” is an attribute which stores solutions for removing abnormality in the datacenter 1, and is set in advance in accordance with the attribute “type of abnormality.”

In the following, rows d1 to d6 in the comprehensive judgment database DB4 will be described.
First row d1

The first row d1 represents the case where the attribute “state pattern” is “pattern A”, the attribute “temperature” is “x”, and the attribute “error” is “x”.

When the state pattern is in “pattern A”, the cooling wind W is backward wind as illustrated in FIG. 7. This is because when the opening portion 2a is close to the air conditioner 3, strong cooling wind W immediately after flowing out of the air conditioner 3 gets disturbed in the vicinity of the opening portion 2a, thereby forming an air curtain in the datacenter 1.

Moreover, the attribute “temperature” becomes “x” because such disturbance of the cooling wind W makes it difficult for the cooling wind W to be taken into the rack 4, thereby increasing the temperature T in the rack 4. Further, the attribute “error” becomes also “x” because the increase in the temperature T results in insufficient cooling of electronic component 5a, and the electronic component 5a therefore outputs the error information S_{E}.

When the electronic component 5a is left in such a state, the performance of the electronic component 5a significantly decreases. Therefore, the attribute “comprehensive judgment” in this case becomes “improvement required”.

Moreover, the attribute “type of abnormality” is “air curtain state” due to the disturbance of the cooling wind W as mentioned above.

In the attribute “solution”, a measure to lower the temperature T to or below the reference temperature and to stop the error information S_{E} is stored.

Examples of such a measure include installing a flow regulating plate underneath the floor 2 for regulating the flow of the cooling wind W to solve the “air curtain state.”

Also, it is possible to lower the temperature T to or below the reference temperature and stop the error information S_{E} by adjusting the number of rotations of each fan 8 based on how the cooling wind W is disturbed so that a sufficient volume of the cooling wind W can be taken into the rack 4.
Second row d2

In the second row d2, the attribute “state pattern” is “pattern B”, and the other attributes are the same as those in the first row.

When the state pattern is in “pattern B”, the wind speed of the cooling wind W is low in regions of the opening portion 2a closer to the air conditioner 3, as illustrated in FIG. 8.

This is because an air curtain is formed when the opening portion 2a is close to the air conditioner 3, as in the case of “pattern A”.

For this reason, the attribute “type of abnormality” and the attribute “solution” are the same as those in the first row dl.
Third row d3

The third row d3 represents the case where the attribute “state pattern” is “pattern C”, the attribute “temperature” is “⊚”, and the attribute “error” is “⊚”.

When the state pattern is in “pattern C”, the cooling wind W is forward wind and the wind volume of the cooling wind W is equal to or higher than the reference wind speed in all the regions of the opening portion 2a, as illustrated in FIG. 9. Moreover, the attribute “temperature” and the attribute “error” are both “⊚”.

Therefore, in this case, the datacenter 1 can be regarded as having no abnormality. Hence, “comprehensive judgment” is “no improvement required”. Moreover, the attribute “solution” is “none”.
Fourth row d4

The fourth row d4 represents the case where the attribute “state pattern” is “pattern C”, the attribute “temperature” is “x”, and the attribute “error” is “x”.

This is the case where the cooling wind W is forward wind, and the wind volume is equal to or higher than the reference wind speed, but the temperature T is equal to or higher than the reference temperature, and the error information S_{E} is being outputted. A possible cause of this state may be the failure of a fan 8 (see FIG. 1), and the cooling wind W is not being taken into the rack 4 by the fan 8.

Therefore, the attribute “type of abnormality” is “abnormality of fan 8,” and the attribute “comprehensive judgment” is “improvement required”.

Moreover, the attribute “solution” is “check fan 8”.
Fifth raw d5

The fifth raw 5d represents the case where the attribute “state pattern” is “pattern D”, the attribute “temperature” is “x”, and the attribute “error” is “x”.

When the state pattern is in “pattern D”, the wind volume of the cooling wind W is low at edges of the opening portion 2a, as illustrated in FIG. 10. Due to this insufficient wind volume, the attribute “temperature” and the attribute “error” are both “x”.

When the electronic component 5a is left in such a state, the performance of the electronic component 5a significantly decreases. Therefore, the attribute “comprehensive judgment” in this case is “improvement required”.

Moreover, the attribute “type of abnormality” is “insufficient wind volume” of the cooling wind W as mentioned above.

In the case where the wind volume of the cooling wind W is insufficient in this manner, the number of rotations of each fan 8 may be increased to take more cooling wind W into the rack 4 so that the electronic components 5a can be cooled appropriately.

Therefore, “increase the number of rotations of fan 8” is stored in the attribute “solution”.
Six raw d6

The sixth raw d6 represents the case where the attribute “state pattern” is “pattern E”, the attribute “temperature” is “x”, and the attribute “error” is “x”.

When the state pattern is in “pattern E”, the cooling wind W is absent, as illustrated in FIG. 11. Therefore, it is impossible to cool the electronic component 5a with the cooling wind W. Thus, the attribute “temperature” and the attribute “error” are both “x”.

A possible cause of the absence of the cooling wind

W may be failure of the air conditioner 3.

Therefore, the attribute “type of abnormality” is “failure of air conditioner 3”, and the attribute “comprehensive judgment” is “improvement required”.

Moreover, the attribute “solution” is “check air conditioner 3”.

Next, a monitoring method according to the present embodiment using the above described monitoring device 20 will be described.

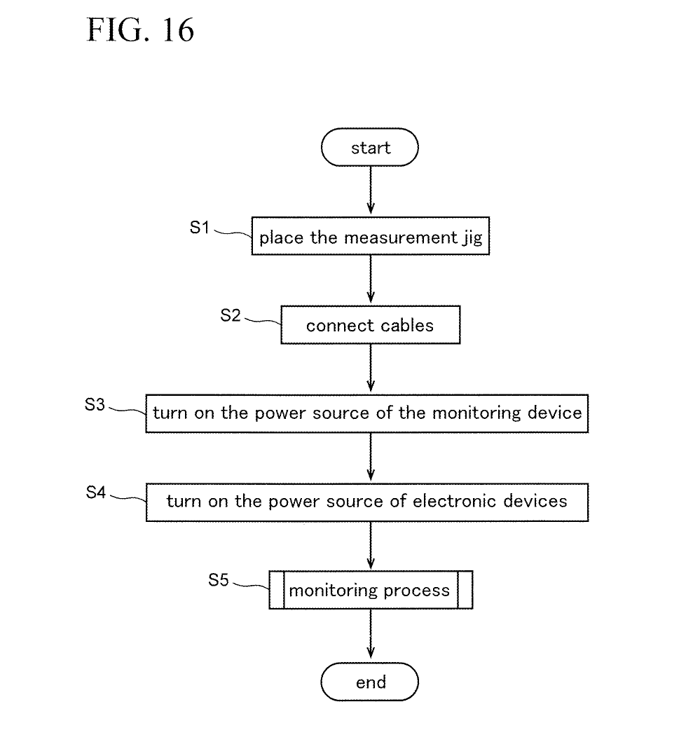

FIG. 16 is a flowchart illustrating the whole procedure of the monitoring method according to the present embodiment.

First, in step S1, the measurement jigs 12 (see FIG. 3) are placed on the opening portion 2a.

Then, the method proceeds to step S2, in which the measurement jig 12 and the monitoring device 20 are connected to each other with the RS-232C cable 29 (see FIG. 5). Further, electronic device 5 and the monitoring device 20 are connected with the LAN cable 20.

Then, the method proceeds to step S3, in which the power source 51 (see FIG. 5) of the monitoring device 20 is turned on.

Thereafter, the method proceeds to step S4, in which the power source 52 (see FIG. 5) of each electronic device 5 is turned on.

Next, the method proceeds to step S5, in which the monitoring device 20 starts a monitoring process on the datacenter 1.

This monitoring process is performed by executing the specialized program installed in advance in the hard disk 24 (see FIG. 5).

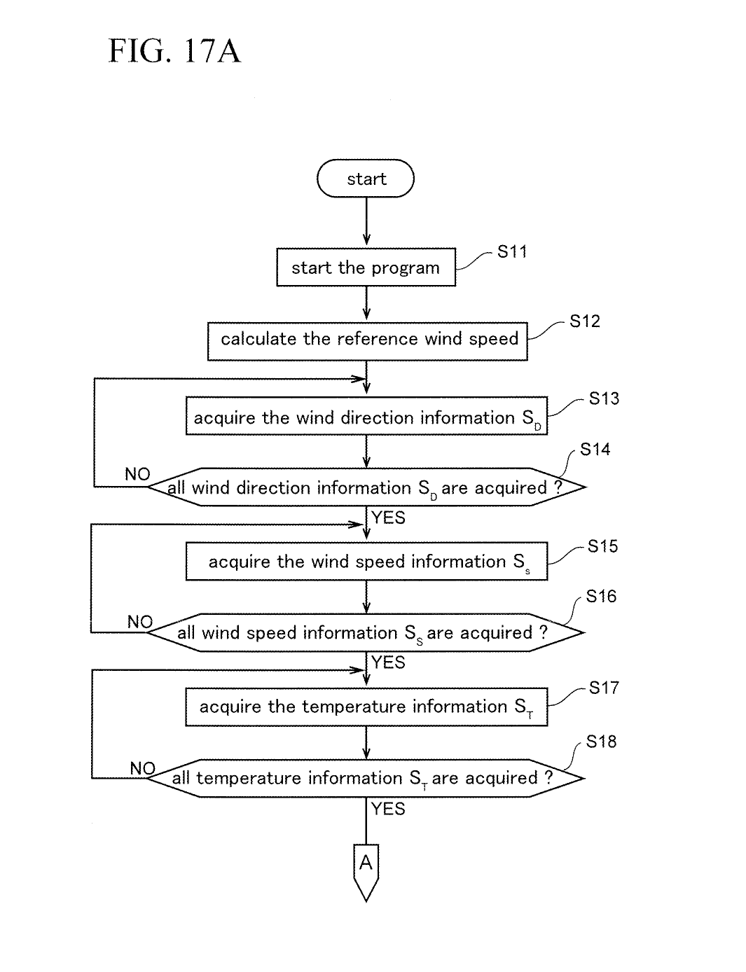

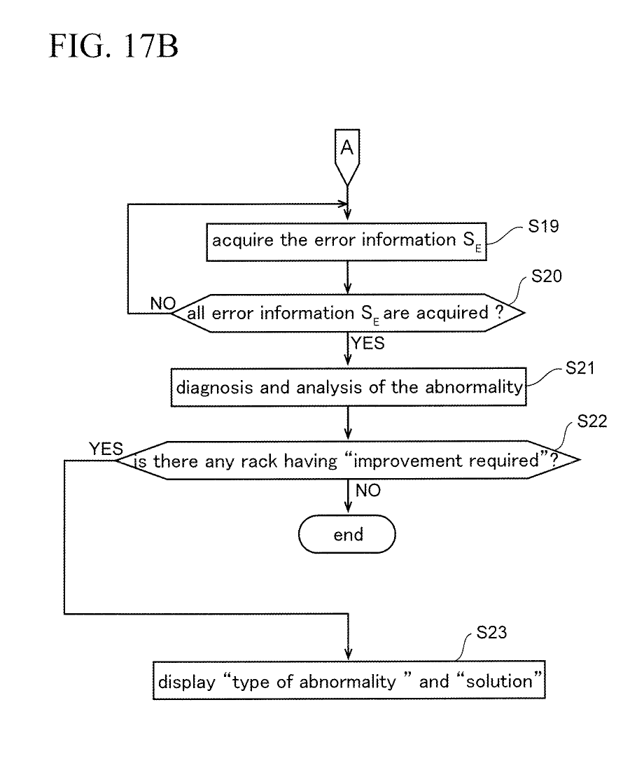

FIGS. 17A and 17B are flowcharts illustrating the procedure of the monitoring process in step S5.

First, in step S11 in FIG. 17A, the monitoring device 20 starts the specialized program for performing this monitoring process.

Then, the process proceeds to step S12, in which the user inputs the reference wind volume and the area of the opening portion 2a into the monitoring device 20.

The monitoring device 20 then calculates the reference wind speed, which is defined as (reference wind volume)/(area of opening portion 2a).

Subsequently, the process proceeds to step S13, in which the wind direction acquiring unit 42 (see FIG. 6) acquires the wind direction information S_{D} from each wind direction sensor 15 (see FIG. 3).

Then, the process proceeds to step S14, in which the wind direction acquiring unit 42 determines whether or not the wind direction information S_{D} is acquired from all the wind direction sensors 15 in all the opening portions 2a.

Here, when it is determined that the acquisition is not completed (NO), the process returns to step S13 and the wind direction acquiring unit 42 continues acquiring the wind direction information S_{D}.

On the other hand, when it is determined that the acquisition is completed (YES), the process proceeds to step S15.

In step S15, the wind speed acquiring unit 41 (see FIG. 6) acquires the wind speed information S_{S} from each wind speed sensor 13 (see FIG. 3).

Then, the process proceeds to step S16, in which the wind speed acquiring unit 41 determines whether or not the wind speed information S_{S} is acquired from all the wind speed sensors 13 in all the opening portions 2a.

Here, when it is determined that the acquisition is not completed (NO), the process returns to step S15, and the wind speed acquiring unit 41 continues acquiring the wind speed information S.

On the other hand, when it is determined that the acquisition is completed (YES), the process proceeds to step S17.

In step S17, the temperature acquiring unit 43 (see FIG. 6) acquires the temperature information S_{T} from each temperature measuring unit 6 (see FIG. 1).

Then, the process proceeds to step S18, in which the temperature acquiring unit 43 determines whether or not the temperature information S_{T} is acquired from all the temperature measuring units 6.

Here, when it is determined that the acquisition is not completed (NO), the process returns to step S17, and the temperature acquiring unit 43 continues acquiring the temperature information S_{T}.

On the other hand, when it is determined that the acquisition is completed (YES), the process proceeds to step S19 in FIG. 17B.

In step S19, the error information acquiring unit (see FIG. 6) acquires the error information S_{E} from each error detecting unit 7 (see FIG. 1).

Then, the process proceeds to step S20, in which the error information acquiring unit 44 determines whether or not the error information S_{E} on all the electronic components 5a is acquired.

Here, when it is determined that the acquisition is not completed (NO), the process returns to step S19, and the error information acquiring unit 44 continues acquiring the error information S_{E}.

On the other hand, when it is determined that the acquisition is completed (YES), the process proceeds to step S21.

In step S21, diagnosis and analysis of the abnormality in the datacenter 1 are made as follows.

First, it is specified which one of the preliminarily categorized state patterns A to E in the state pattern database DB1 (see FIG. 12) is matched with the state of the cooling wind W at each opening portion 2a. In this example, the state pattern specifying unit 45 specifies the state pattern of the cooling wind W by reading, from the state pattern database DB1, the state pattern which matches the wind direction information S_{D} and the wind speed information S_{S} acquired in the step S13 and the step S15 respectively.

Note that in the case where the state patterns are categorized into the state patterns A to E based only on wind speeds, the state pattern may be specified based only on the wind speed information S.

Next, the abnormality specifying unit 46 specifies the type of abnormality in the datacenter 1.

To specify the type of abnormality, the abnormality specifying unit 46 acquires the attribute value “⊚” or “x” from the temperature database DB2 based on the value of the temperature T contained in the temperature information S_{T} acquired in step S17. Note that this attribute value is acquired for each rack 4.

Further, by utilizing the error information S_{E} acquired in step S19, the abnormality specifying unit 46 acquires the attribute value “⊚” or “x” from the error database DB3. This attribute value is also acquired for each rack 4.

Then, from the comprehensive judgment database DB4, the abnormality specifying unit 46 calls the row which correspond to the specified state patterns, the attribute values in the temperature database DB2, and the attribute values in the error database DB3.

As a result, “comprehensive judgment”, “type of abnormality”, and “solution” can be obtained for each rack 4.

Then, the process proceeds to step S22.

In step S22, the abnormality specifying unit 46 determines whether or not there is any rack 4 having “improvement required” in “comprehensive judgment” acquired in step S21.

Here, when there is no rack 4 having “improvement required,” there is no need to improve the environment in the datacenter 1. Thus, the monitoring method according to the present embodiment ends.

On the other hand, when there is a rack 4 having “improvement required,” the process proceeds to step S23, in which “type of abnormality” and “solution” of that rack 4 are displayed on the displaying unit 27 under the control of the abnormality specifying unit 46.

In this way, the user can find “type of abnormality” and “solution,” and take a measure to solve the abnormality in the datacenter 1 by following that “solution.”

By the above operation, the basic steps of the monitoring method according to the present embodiment end.

According to the present embodiment described above, it is specified which one of the plurality of state patterns stored in the state pattern database DB1 is matched with the state of the cooling wind, based on the wind speed and wind direction of the cooling wind W at the opening portion 2a. Then, the type of abnormality in the datacenter 1 is specified based on that state pattern. In this way, the user can take a measure suitable for the type of abnormality. Thus, it is possible to prevent decrease in the performance of the electronic apparatuses 5 due to insufficient cooling and the like of their electronic components 5a.

Further, the type of abnormality is specified by taking into consideration the temperature T in the rack 4 and the error information S_{E} sent from the electronic components 5a, in addition to the state pattern of the cooling wind W. Thus, the accuracy of specification of the type of abnormality is improved.

Furthermore, since the solution is presented to the user in addition to the type of abnormality, the measure taken to solve the abnormality becomes clear, which contributes to the convenience of the user.

Next, the examinations conducted by the inventor of the present application will be described.

(First Examination)

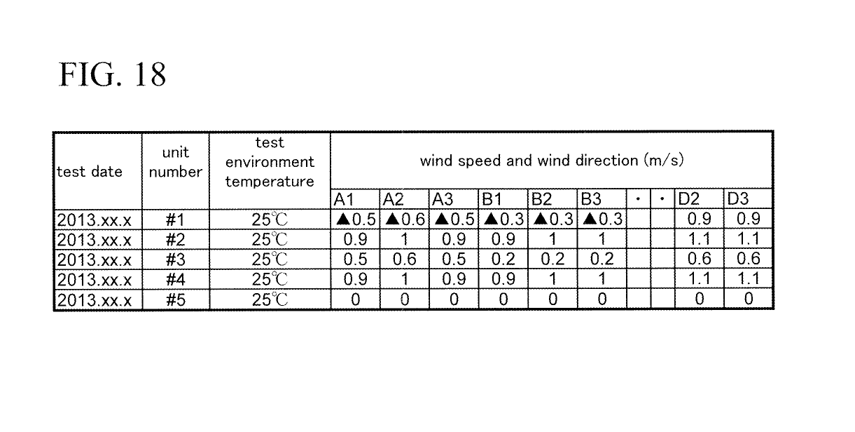

FIG. 18 is a table schematically illustrating wind speeds and wind directions acquired in this examination.

In FIG. 18, “test date” represents the date on which this examination was conducted, and “unit number” represents numbers for specifying one rack 4 from a plurality of racks 4. Moreover, “test environment temperature” represents the temperature in a datacenter 1 acquired for reference.

Note that in this examination, the wind speed and wind direction of cooling wind W at each of the opening portions 2a situated immediately below the racks 4 were studied. Reference signs A, B, C, D, 1, 2, and 3 in FIG. 18 are reference signs for specifying each virtual region R in each opening portion 2a, as illustrated in FIG. 2. For example, Al is the virtual region R at the row 1 and the column A. Also, reference sign ▴ indicates that the cooling wind W is backward wind.

As illustrated in FIG. 18, there is backward wind immediately below the #1 rack 4 in this example.

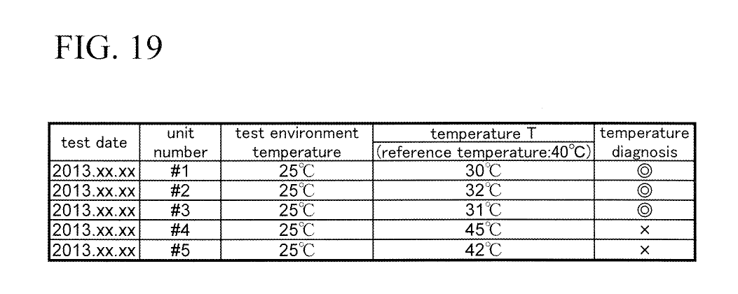

FIG. 19 is a table schematically illustrating the temperature T inside each rack 4 acquired in this examination.

Note that in FIG. 19, “temperature diagnosis” indicates results of determination as to whether or not the temperature T is higher than a reference temperature, by using symbols “⊚” and “x” which are the same attribute values as those in the temperature database DB2 (see FIG. 13). In this examination, the reference temperature is set to 40° C.

As illustrated in FIG. 19, the temperature T is higher than the reference temperature in the #4 and #5 racks 4.

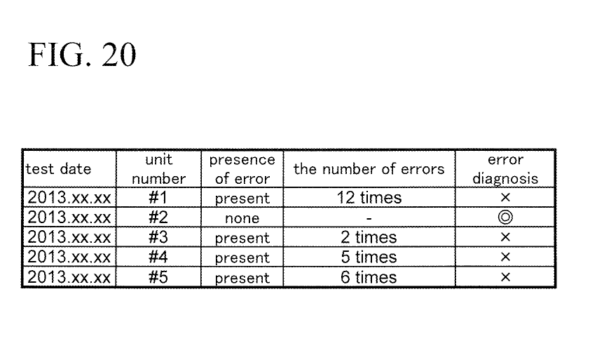

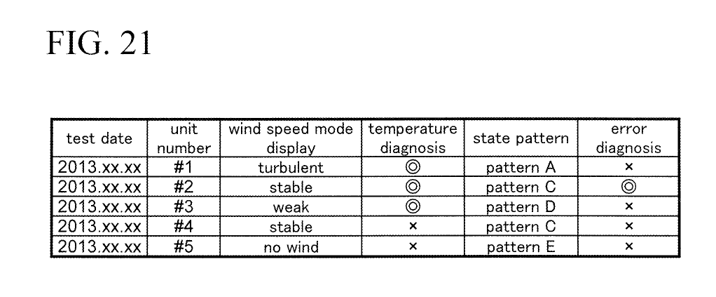

FIG. 20 is a table schematically illustrating the error information S_{E} acquired in this examination.

In FIG. 20, “presence of error” indicates whether or not any one of the plurality of electronic components 5a in the rack 4 is experiencing failure. Moreover, “error diagnosis” indicates the same information with symbols “⊚” and “x” which are the same attribute values as those in the error database DB3 (see FIG. 14).

Further, “the number of errors” indicates the number of errors that has occurred in one hour, and acquired for reference.

As illustrated in FIG. 20, in this examination, only the #2 rack 4 had “⊚” and the other racks 4 had “x”.

FIG. 21 was obtained when “wind speed mode display” is checked based on the examination results in FIGS. 18 to 20.

FIG. 21 is a table gathering the results of this examination. Note that “wind speed mode display” in FIG. 21 is the same as “wind speed mode display” in FIGS. 7 to 11.

As illustrated in FIG. 21, only the #2 and #4 racks 4 had “stable” in “wind speed mode display”, and the other racks 4 had “turbulent”, “weak”, and “no wind” in “wind speed mode display”.

(Second Examination)

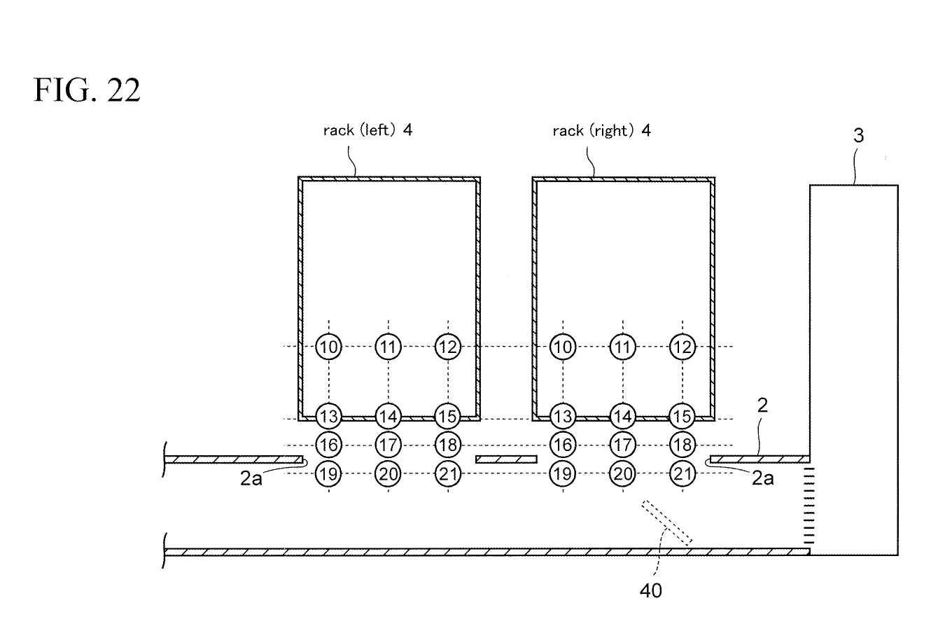

FIG. 22 is a side view schematically illustrating racks 4 and its periphery used in this examination.

As illustrated in FIG. 22, two racks 4 were used in this examination. These racks 4 are distinguished below as the rack (left) 4 and the rack (right) 4.

The rack (left) 4 is the rack in which no failure has occurred, whereas the rack (right) 4 is the rack in which failures occurred frequently.

Moreover, in this examination, in addition to the wind speed measuring points P_{S} and the wind direction measuring points P_{D} in the opening portion 2a illustrated in FIG. 2, wind speed measuring points and wind direction measuring points were also provided at the height indicated by the circled numbers 10 to 21. Among these measuring points, the measuring points 10 to 12 are located in the rack 4, and the measuring points 13 to 15 are located at the inlet of the rack 4. Moreover, the measuring points 16 to 18 are located between the floor 2 and the rack 4, and the measuring points 19 to 21 are located below the floor 2.

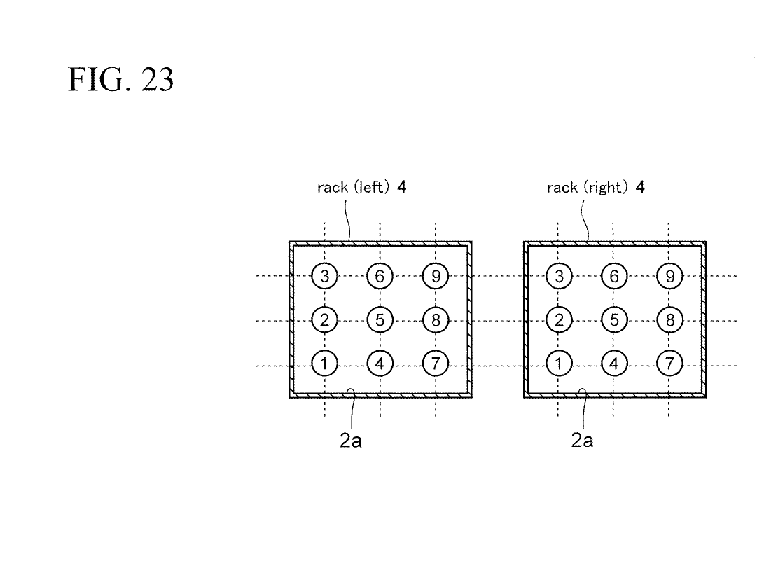

FIG. 23 is a plan view schematically illustrating the opening portions 2a immediately below the racks 4 in FIG. 22.

Circled numbers 1 to 9 in FIG. 23 are the reference signs indicating the in-plane positions at the measuring points indicated by 10 to 21 in FIG. 22.

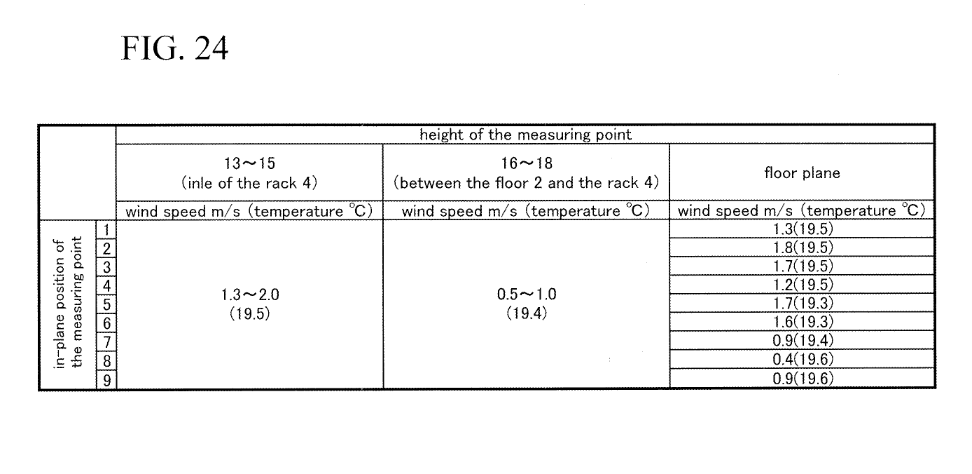

FIG. 24 is a table illustrating the results of measurement of the wind speed and wind direction of the cooling wind W at the measuring points 13 to 18 in the rack (left) 4. In this examination, the temperature of the cooling wind W was studied at each measuring point, and its results are given in parentheses in FIG. 24 as well.

Also, the reference wind speed for the cooling wind W was set to 0.4 m/sec.

Note that “floor plane” in FIG. 24 indicates the results of measurement at the wind speed measuring points P_{S} and the wind direction measuring points P_{D} set in the opening portion 2a as illustrated in FIG. 2.

As illustrated in FIG. 24, the cooling wind W is forward wind, and wind speeds higher than the reference wind speed are obtained at the measuring points 13 to 18 and “floor plane.”

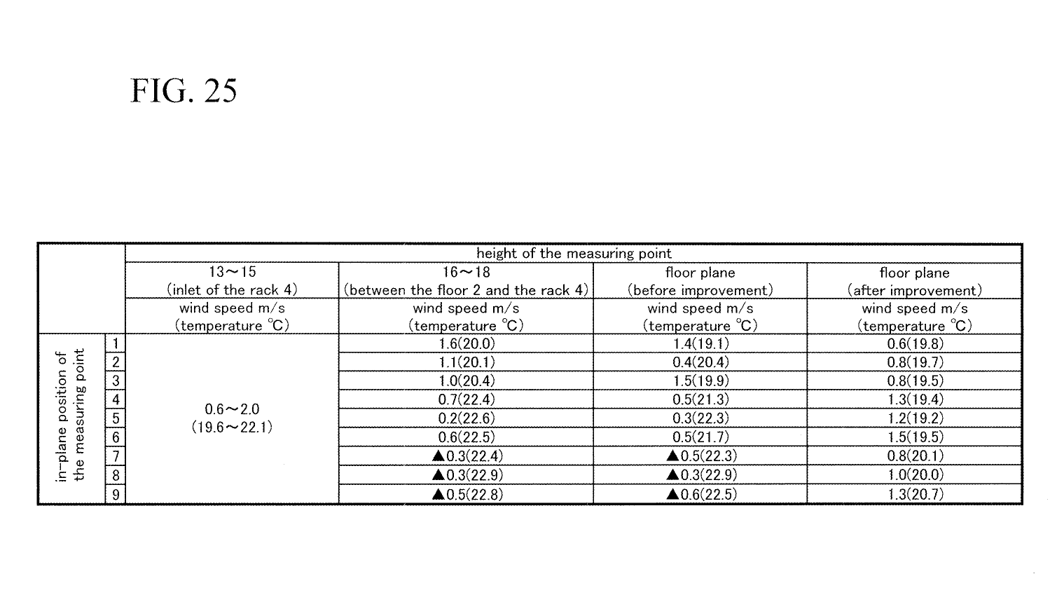

Meanwhile, FIG. 25 is a table obtained by conducting the same examination on the rack (right) 4.

As can be seen from “floor plane (before improvement)” in FIG. 25, the cooling wind W is backward wind and the wind speed thereof is lower than the reference wind speed (0.4 m/sec) in some part of the floor plane for the rack (right) 4.

By studying this situation based on the present embodiment, placing a flow regulating plate was proposed as “solution”.

To this end, as illustrated by a dotted line in FIG. 22, a flow regulating plate 40 was placed underneath the opening portion 2a to supply a large portion of the cooling wind W from the air conditioner 3 into the rack (right) 4.

As a result, as illustrated in “floor plane (after improvement)” in FIG. 25, the cooling wind W became forward wind and the wind speed thereof became higher than the reference wind speed, which was 0.4 m/sec, at the floor plane.

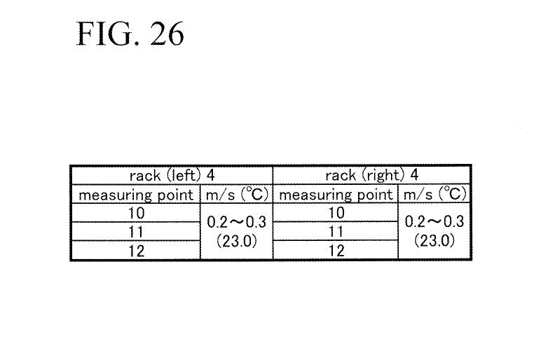

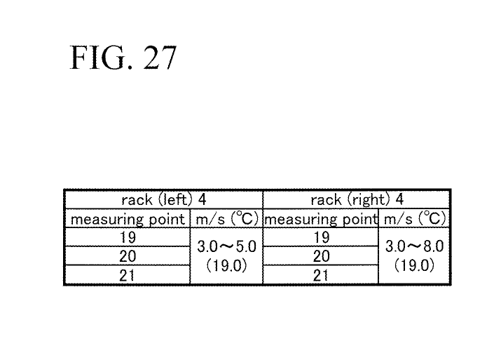

Meanwhile, FIG. 26 is a table illustrating the results of measurement of the wind speed and the wind direction at the measuring points 10 to 12 in each of the rack (left) 4 and the rack (right) 4. Also, FIG. 27 is a table illustrating the results of measurement of the wind speed and the wind direction at the measuring points 19 to 21 in each of the rack (left) 4 and the rack (right) 4.

As mentioned above, the measuring points 10 to 12 are located in the rack 4, while the measuring points 19 to 21 are located below the floor 2.

According to the results in FIG. 26 and FIG. 27, there is no large difference between the left and right racks 4 in the results of measurement at the measuring points 10 to 12 and 19 to 21, despite that failures have occurred in different ways in the left and right racks 4 as mentioned above. This means that it will be impossible to find failures in the electronic apparatuses 5 in each rack 4 if the wind speed and wind direction of the cooling wind W are measured in the rack 4 or below the floor 2.

From this, it is confirmed that it is effective to set the wind speed measuring points P_{S} and the wind direction measuring points P_{D} in the opening portion 2a as in the present embodiment, in order to make a failure diagnosis on the datacenter 1 including the electronic apparatuses 5.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A monitoring device comprising:
a wind speed acquiring unit that acquires a wind speed of a cooing wind at each of a plurality of wind speed measuring points set in an opening portion of a floor of a datacenter, the cooling wind being supplied through the opening portion into an electronic apparatus;
a state pattern specifying unit that specifies which one of a plurality of preliminarily categorized state patterns is matched with a state of the cooling wind, based on the wind speed at each of the wind speed measuring points; and
an abnormality specifying unit that specifies a type of abnormality in the datacenter based on the specified state pattern.

2. The monitoring device according to claim 1, further comprising a wind direction acquiring unit that acquires a wind direction of the cooling wind at each of a plurality of wind direction measuring points set in the opening portion, wherein
the state pattern specifying unit specifies the state pattern based on the wind speed and the wind direction.

3. The monitoring device according to claim 2, further comprising a temperature acquiring unit that acquires a temperature of the electronic apparatus, wherein
the abnormality specifying unit specifies the type of abnormality based on the specified state pattern and the temperature.

4. The monitoring device according to claim 3, further comprising an error information acquiring unit that acquires error information on a presence of an error in an electronic component in the electronic apparatus, wherein
the abnormality specifying unit specifies the type of abnormality based on the specified state pattern, the temperature, and the error information.

5. The monitoring device according to claim 1, wherein the abnormality specifying unit specifies a solution for the type of abnormality.

6. The monitoring device according to claim 1, further comprising a displaying unit that displays the type of abnormality.

7. The monitoring device according to claim 1, further comprising a database in which the state patterns and the types of abnormality are associated with each other, wherein
the abnormality specifying unit specifies the type of abnormality corresponding to the specified state pattern by referring to the database.

8. A monitoring method comprising:
acquiring, by a wind speed acquiring unit, a wind speed of a cooing wind at each of a plurality of wind speed measuring points set in an opening portion of a floor of a datacenter, the cooling wind being supplied through the opening portion into an electronic apparatus;
specifying, by a state pattern specifying unit, which one of a plurality of preliminarily categorized state patterns is matched with a state of the cooling wind, based on the wind speed at each of the wind speed measuring points; and
specifying, by an abnormality specifying unit, a type of abnormality in the datacenter based on the specified state pattern.

9. The monitoring method according to claim 8, further comprising:
acquiring, by a wind direction acquiring unit, a wind direction of the cooling wind at each of a plurality of wind direction measuring points set in the opening portion, wherein
in the specifying the state pattern, the state pattern specifying unit specifies the state pattern based on the wind speed and the wind direction.

10. The monitoring method according to claim 9, further comprising:
acquiring, by a temperature acquiring unit, a temperature of the electronic apparatus, wherein
in the specifying the type of abnormality, the abnormality specifying unit specifies the type of abnormality based on the specified state pattern and the temperature.

11. The monitoring method according to claim 10, further comprising:
acquiring, by an error information acquiring unit, error information on a presence of an error in an electronic component in the electronic apparatus, wherein
in the specifying the type of abnormality, the abnormality specifying unit specifies the type of abnormality based on the specified state pattern, the temperature, and the error information.

12. A monitoring device comprising:
a memory configured to store a program; and
a processor, in accordance with the program, configured to execute:
acquiring a wind speed of a cooing wind at each of a plurality of wind speed measuring points set in an opening portion of a floor of a datacenter, the cooling wind being supplied through the opening portion into an electronic apparatus that is in the data center;
specifying which one of a plurality of preliminarily categorized state patterns is matched with a state of the cooling wind, in accordance with the wind speed at each of the wind speed measuring points; and
specifying a type of abnormality in the datacenter in accordance with the specified state pattern.
